(19) United States
(12) Patent Application Publication
(10) Pub. No.: US 2003/0121209 A1
(43) Pub. Date: Jul. 3, 2003

(54) Door edge protector

(75) Inventor: Robert W. Flesher, Baltimore, MD (US)

Correspondence Address: STERNE, KESSLER, GOLDSTEIN & FOX PLLC, 1100 NEW YORK AVENUE, N.W., WASHINGTON, DC, 20005, US

(73) Assignee: Apogee Designs Ltd.

(21) Appl. No.: 09/852,737

(22) Filed: May 11, 2001

(51) Int. Cl. B60J 5/00

(52) U.S. Cl. 49/462

(57) ABSTRACT

An edge protector for a vehicle door includes a bladder formed from a pliable material and a clip for coupling the bladder a door edge. The bladder includes a top layer and a bottom layer formed of a pliable material. The layers are sealed together along a peripheral edge. The bladder includes an inflation port for filling the bladder with a fluid. The clip is a U-shaped plastic clip that is formed to meet and secure to the edge of a vehicle door. The plastic clip is sealed to the bottom layer of the bladder by a heat seal or an adhesive. The ends of the seal are rounded to reduce stress points. The peripheral edge of the door protector is radiused to equalize pressure around the seal for increased burst strength.

### BACKGROUND OF THE INVENTION

1. Field of the Invention

The present invention relates generally to devices for protecting edges of doors from chipping and scratching that can occur when the door edge contacts some object. More particularly, the present invention relates to an airbag attached to or near the door edge of an automobile door for protecting and cushioning the door edge from direct contact with other objects that could cause chips, scratches or dents in the door edge surface.

2. Background Art

During vehicle manufacturing, vehicle doors and vehicle bodies are manufactured on separate assembly lines. The door line and the vehicle body line converge at some point, and the doors are attached to the vehicle bodies. The doors are attached by hinges to the vehicle body, allowing the doors to swing. During the early assembly process, the doors are not attached to restraining devices that would keep them from swinging all the way open and contacting nearby machinery or other items. Accordingly, care must be taken to ensure that the car doors are not opened or allowed to swing open where they could contact assembly line equipment or other objects that could cause damage to the doors.

After manufacturing, the vehicles are delivered to car dealerships on large trucks or trains. The trailers and train cars that deliver cars are designed with very little excess space to maneuver the cars. Accordingly, the walls and sides of the trailers and train cars fit closely to the exterior of the car. Each car that is to be delivered on a truck or train is driven onto the truck or train by a driver. After the driver drives the car onto the trailer or train car, he must open the vehicle door in the tight space provided on the trailer or train car to exit the vehicle. The door edge can contact the trailer body or the train body, causing chips, dents, or scratches in the paint on the car door.

Once the car is delivered to the dealership, a driver must again enter the car on the trailer, requiring that the vehicle door again be opened within the tight confines provide prior to being driven off of the trailer or train car, and parked in a dealership's lot.

Once on the dealership lot, new cars are typically parked close together in order to conserve lot space. Again, there is a possibility that the doors will be opened and the door edge will contact and damage either the car door or the adjacent vehicle. If that happens, the door edges and the adjacent vehicle can be scratched, dented, or otherwise marred.

Repair to damaged doors can be costly and time-consuming, and must be completed prior to selling the vehicle to a consumer. Accordingly, it is in the interest of vehicle manufacturers, deliverers and dealerships to protect the edges of doors from scratches and dents as the doors are opened.

Edge guards have been developed to protect the door edges from such contact with other vehicles, the delivery trailer, or manufacturing machinery. Several edge protectors are known in the art. Some edge protectors fit directly over the edge of the vehicle door. Other edge protectors are foam pieces that will be adhered to or near the edge of the door so that when a door is opened, the foam piece contacts the adjacent vehicle door or trailer or manufacturing machinery.

Because such edge protectors and the attachment materials can be expensive, manufacturers often recycle the door protectors by taking them off the door when the vehicle to which the door is attached is completed. Accordingly, there is no protection during delivery of the vehicle and during the period of time that the vehicle is on the dealership lot.

There is a need for an inexpensive, easy-to-manufacture door guard that can be placed on a vehicle door at the point of manufacture and can be left in place on the vehicle door through delivery and while parked on the dealership lot.

### BRIEF SUMMARY OF THE INVENTION

The invention is an edge protector for a vehicle door. The edge protector includes a bladder formed from a pliable material and a means for coupling the bladder to a door edge. The bladder includes a top layer and a bottom layer formed of a pliable material. The layers are sealed together along a peripheral edge. The bladder includes an inflation port for filling the bladder with a fluid, such as a gas, liquid or gel. The means for coupling the bladder to a door edge includes an attachment device, such as a U-shaped plastic clip that is formed to meet and secure to the edge of a vehicle door. The plastic clip is sealed to the bottom layer of the bladder by a heat seal or an adhesive. The ends of the seal are rounded to reduce stress points. The peripheral edge of the door protector is radiused to equalize pressure around the seal for increased burst strength.

### BRIEF DESCRIPTION OF THE FIGURES

The foregoing and other features and advantages of the invention will be apparent from the following, more particular description of preferred embodiments of the invention, as illustrated in the accompanying drawings.

FIG. 1 shows a top view of a door protector of the present invention.

FIG. 2 shows a side view of the door protector of FIG. 1.

FIG. 3 shows a bottom view of the door protector of FIG. 1.

FIG. 4 shows an alternative embodiment of a door protector of the present invention.

FIG. 5 shows a top view of the embodiment of the door protector of FIG. 4.

FIG. 6 shows a cross-sectional view taken along lines 6-6 of FIG. 5.

FIG. 7 shows another alternative embodiment of a door protector of the present invention.

FIG. 8 is a cross-sectional view taken along lines 8-8 of FIG. 7.

FIG. 9 is a production machine for manufacturing the door protector of the present invention.

FIG. 10 shows strip material and the door protector of the present invention in an uninflated state after processing by the production machine shown in FIG. 9.

FIG. 11 shows a line-side dispensing machine for inflating the door protector of the present invention.

### DETAILED DESCRIPTION OF THE INVENTION

The preferred embodiments of the present invention are now described with reference to the figures where like reference numbers indicate identical or functionally similar elements. While the invention is described in terms of specific embodiments, it should be understood that this is done for illustrative purposes only. A person skilled in the relevant art will recognize that various modifications, rearrangements and substitutions can be made without departing from the spirit of the invention.

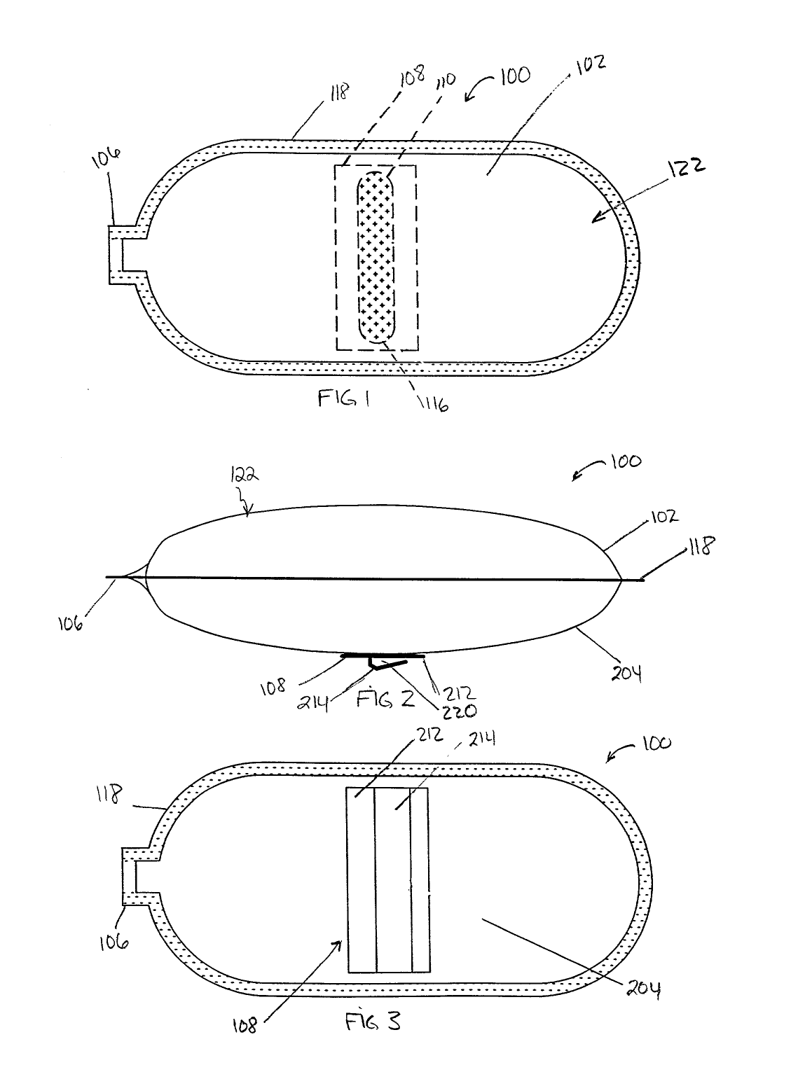

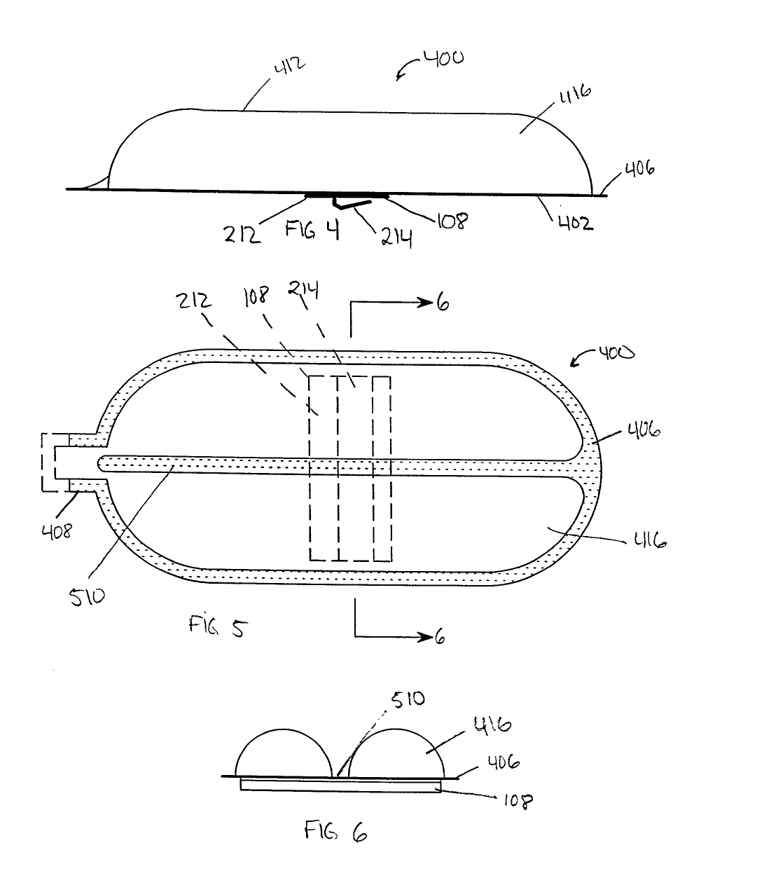

The preferred embodiment of the door protector of the present invention will now be described with reference to FIGS. 1-3. FIG. 1 shows a top view of a door protector 100 having a top layer 102, an inflation port 106 and a peripheral edge 118. Top layer 102 is the portion of a bladder 122 visible in FIG. 1. FIG. 2 shows a side view of a door protector 100 showing top layer 102 and a bottom layer 204. The layers 102 and 204 are sealed together at peripheral edge 118 to form bladder 122.

Top layer 102 and bottom layer 204 are preferably clear, high-density polyethylene or polypropylene sheets having a thickness in the range of 0.002 to 0.006 inch. However, thicker or thinner sheets could be used, as would be apparent to one skilled in the relevant art. Additionally, top layer 102 and bottom layer 204 could be formed from sheets of other materials, as would be apparent to one skilled in the art.

Preferably, bladder 122 includes an inflation port 106 for filling the bladder with a fluid or fluid-like material. The fluid or fluid-like material could be, for example, a liquid such as water; a gas such as air, helium, argon, etc.; or any gel. In a preferred embodiment, the fluid is air. Layers 102 and 204 are sealed together at peripheral edge 118. Preferably, the layers are sealed together with a heat weld applied to the peripheral edge. However, the layers could be sealed together using an adhesive or any other method to form an inflatable chamber between the layers. During manufacturing, when peripheral edge 118 is sealed by heat welding, inflation port 106 may be left unsealed, providing access to the interior of bladder 122 for future inflation of the door protector 100.

Attached to bottom layer 204 is a plastic clip 108 for attaching bladder 122 to a vehicle door. As seen in FIG. 2, plastic clip 108 comprises a base 212 and a U-shaped hook 214. Hook 214 extends from base 212 and has a curvature that forms an inner area 220. In a preferred embodiment, plastic clip 108 is formed of high-density polyethylene and is formed by extrusion. However, plastic clip 108 could be formed using any method, such as molding, cutting or any other method, as would be apparent to one skilled in the relevant art. Furthermore, the material of plastic clip 108 could be any material that is capable of forming a compliant hook, that can extend around an edge of a door. Base 212 and hook 214 could be formed of different materials and could be separately formed.

Plastic clip 108 is formed to be compatible with the edge of a vehicle door. Base 212 and hook 214 fit on opposite sides of the door edge, with hook 214 extending from base 212 around a door edge to secure door protector 100 to the door. Accordingly, the edge of the door is located within inner space 220 during use. One advantage of using plastic clip 108 to attach door protector 100 to a vehicle door is that base 212 of plastic clip 108 rests on the exterior of the door and hook 214 extends around the edge of the door to the interior of the door such that the door may be opened or closed without any need to remove door protector 100 from the vehicle door. Accordingly, because hook 214 extends around the edge of the door when the door is closed, hook 214 is fixed between the door and the car body such that hook 214 is securely attached to the vehicle.

When plastic clip 108 is attached to a vehicle door, bladder 122 is located on the exterior of the door. Accordingly, when the door is opened, bladder 122 swings with the door, providing protection to the door edge as it strikes other objects, such as assembly line machinery, a delivery trailer or train car wall or other vehicles in a dealership lot. Bladder 122 absorbs the impact as the bladder is sandwiched between the door edge and the object. Thus, the edge is protected from direct contact with any object that may cause damage or scratching to the door edge.

Plastic clip 108 has a thickness of around 0.060 inch, but could be more or less thick as would be apparent to one skilled in the art. Plastic clip 108, without bladder 122, provides protection to only the edge of the door. Plastic clip 108, used alone, would protect the edge of the door from scratching or chips when the door edge lightly bumps some object directly on the edge. However, plastic clip does not provide protection from denting that can occur during heavier impacts with an object. The thickness of bladder 122, which could be up to two inches thick or greater, protects the door edge from denting that could occur during heavier impacts. Furthermore, the object which the door edge contacts is cushioned from the door edge, eliminating damage to the object.

One particular advantage of the present invention, is that door protector 100 is inexpensive to manufacture. Door protector members that extend completely down the edge of the door can be expensive because these members require long lengths of material. Door protector 100 includes plastic clip 108, which uses a short length of material, and bladder 122. The amount of material required for door protector 100 is less than the amount of material required to completely cover the length of a door edge. Accordingly, the material cost of door protector 100 is much less than the material cost of a door protector that extends completely down the edge of the door. However, as would be apparent to one skilled in the relevant art, plastic clip 108 could extend any length along the edge of the door, including up to the whole length of the door edge.

Because door protector 100 is inexpensive to manufacture, vehicle manufacturers may leave the door protectors on the vehicle through the manufacturing, delivery, and even the display process. When a vehicle is sold from a dealership lot, the consumer can choose to discard the door protector or leave the door protector on the vehicle to provide protection to the door edge throughout the life of the door protector. Because door protector 100 remains attached to the vehicle during the delivery process, it is important that the door protector be securely attached to the vehicle door.

Hook 214 and base 212 securely hold door protector 100 to the vehicle during transportation of the vehicle, when the door protector may be subject to high-velocity winds.

As can be seen by hidden lines in FIG. 1, plastic clip 108 is sealed to bottom layer 204 at a seal 110. In a preferred embodiment, seal 110 is a heat seal or heat weld. However, plastic clip 108 could be attached to bottom layer 204 by an adhesive or other method, as would be apparent to one skilled in the art. Suitable adhesives could be, but are not limited to, a glue, a cement or tape. Seal 110 has ends 116 that are rounded or radiused to eliminate corners or other sharp point at which the sheet material may be weakened and to reduce the tendency of the bladder to tear. In this embodiment, peripheral edge 118 of door protector 100 is also radiused to equalize pressure around the seal for increased burst strength and to increase the aerodynamic effects. Such a design reduces point stresses which would occur at an edge or corner, reducing any tendency of door protector 100 to tear, burst or pop during use. Additionally, because of the aerodynamic shape of the door protector, the door protector can more easily remain attached to a vehicle door during delivery of the vehicle from the manufacturer to the dealership. However, door protector 100 could be a square, rectangle or other shape as would be apparent to one skilled in the art.

Peripheral edge 118 is preferably one-quarter inch to three-eighths inch sealed width. However, the seal width could be greater or less than this, as would be apparent to one skilled in the art.

FIGS. 4-6 show another embodiment of a door protector 400 of the present invention. Door protector 400 includes a bottom layer 402 of non-pliable material connected to a top layer 412 formed of a pliable material, creating a bladder 416. The non-pliable material could be any plastic sheet, a cardboard or laminate sheet or any other sheet to which top layer 412 could be sealably attached. As described in the previous embodiment, plastic clip 108, having base 212 and hook 214, is attached to bottom layer 402. In this embodiment, plastic clip 108 can be attached to bottom layer 402 by an adhesive or by heat-welding, as would be apparent to one skilled in the relevant art.

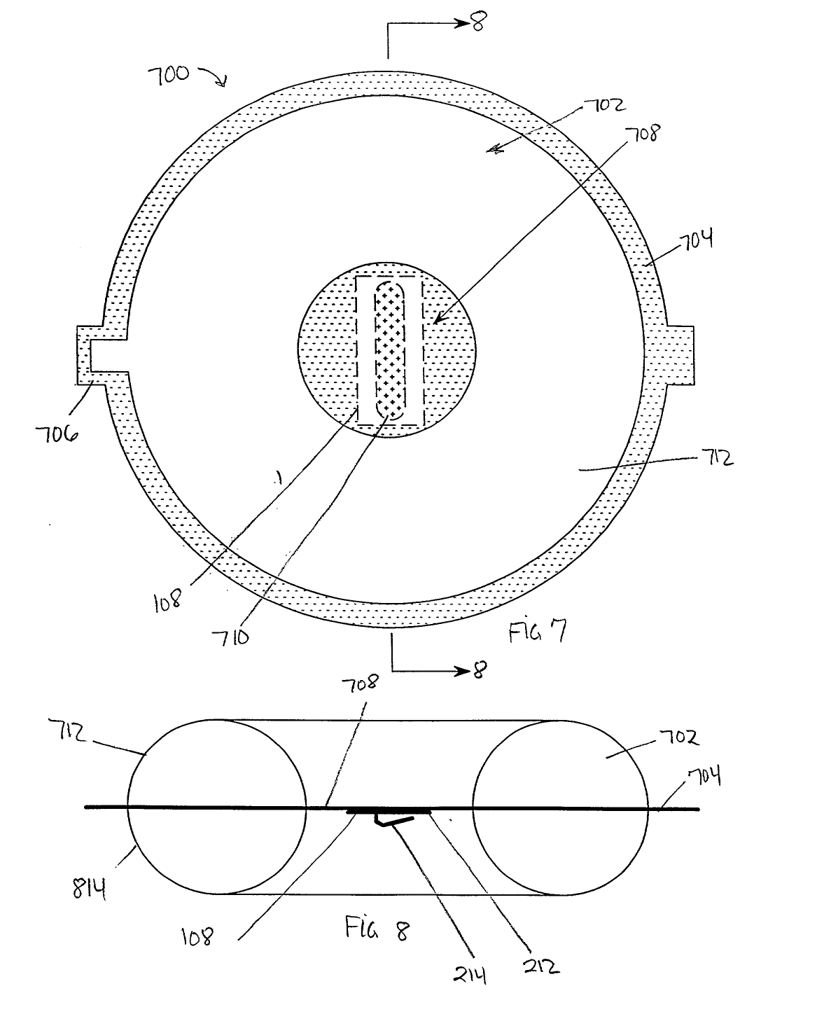

FIG. 5 shows a top view of door protector 400 of FIG. 4. As seen in FIG. 5, door protector 400 is a dual-chamber door protector. Door protector 400 has a peripheral edge 406, sealing top layer 412 to bottom layer 402. Extending from peripheral edge 406 of door protector 400 through bladder 416 and dividing the bladder is a central seal 510. Central seal 510 divides bladder 416 into multiple chambers. In a preferred embodiment, these multiple chambers are in fluid communication with each other. However, as would be apparent to one skilled in the art, the chambers of bladder 416 could be isolated from each other and not include fluid communication.

FIG. 6 is a cross-sectional view taken along lines 6-6 of FIG. 5. FIG. 6 shows bladder 416, plastic clip 108, and peripheral edge 406. FIG. 6 also shows central seal 510 separating the chambers of bladder 416 from each other.

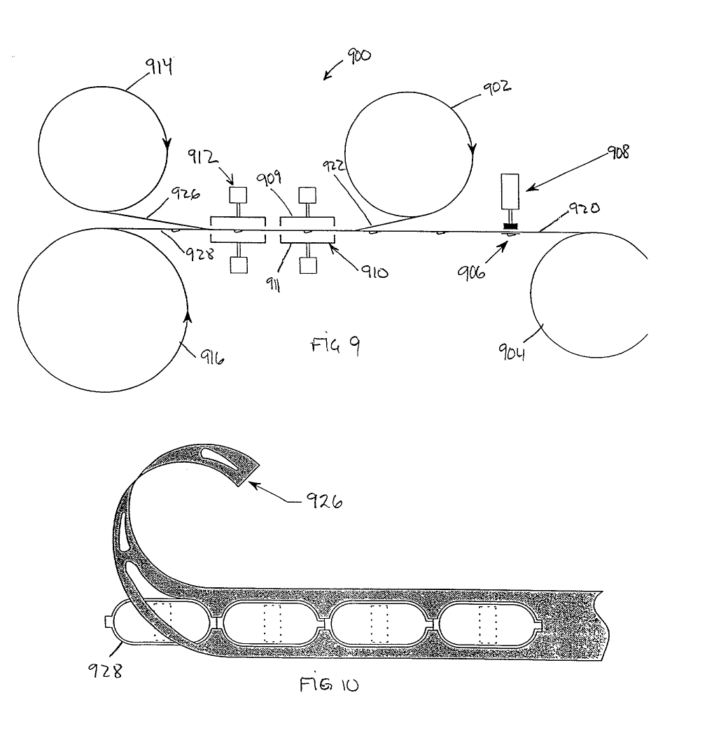

FIGS. 7 and 8 show another embodiment of a door protector 700 of the present invention. FIG. 7 shows a torus-shaped door protector 700 having a bladder 702 and a peripheral edge 704. Door protector 700 includes a top layer 712 and a bottom layer 814, sealed together at peripheral edge 704. Additionally, a central sealed region 708 in the center portion of door protector 700 seals top layer 712 to bottom layer 814, forming a laminate in central sealed region 708.

In the embodiment shown, plastic clip 108 is attached to central sealed region 708. Because there is no inflation at this area, central sealed region 708 can be punctured or heated to attach plastic clip 108 to door protector 700. Accordingly, in this embodiment, plastic clip 108 could be stapled, riveted, glued, or heat-sealed, or connected in any other way that would be apparent to one skilled in the art, to central region 708. As depicted in FIGS. 7 and 8, plastic clip 108 is connected by a heat seal 710 to central region 708.

In an alternative embodiment, the bladder of the door protector is not formed of a top and bottom layer, but is a single layer, such as a balloon. Thus, there is no peripheral edge. The plastic clip is attached directly to the balloon at a convenient location. In another embodiment, the bladder is formed by folding a single material and sealing the material together along the peripheral edges.

The bottom layer, top layer or both layers could be opaque or colored layers and printed with a logo. This would allow either the vehicle manufacturer, or a contractor producing the door protectors to print within or onto the top or bottom layer of the present invention. Likewise, a card bearing a logo or advertisement could be placed within the bladder when the bladder is formed of at least one clear layer.

In an alternative embodiment, the bladder is attached to the vehicle door using an adhesive, such as tape. In this embodiment, the tape is attached to the bottom layer of the bladder, and extends from the bottom layer, around the door edge. The bladder is located at or near the door edge, and securely held in place by the tape. Double-sided tape or single sided tape could be used in this embodiment. Any other type of non-tape adhesive could also be used, as would be apparent to one skilled in the art.

In another alternative embodiment, the bladder is attached to the vehicle door using suction cups. The suction cups are secured to the bladder using an adhesive or other means. The bladder is attached by suction cups at or near the edge of the door.

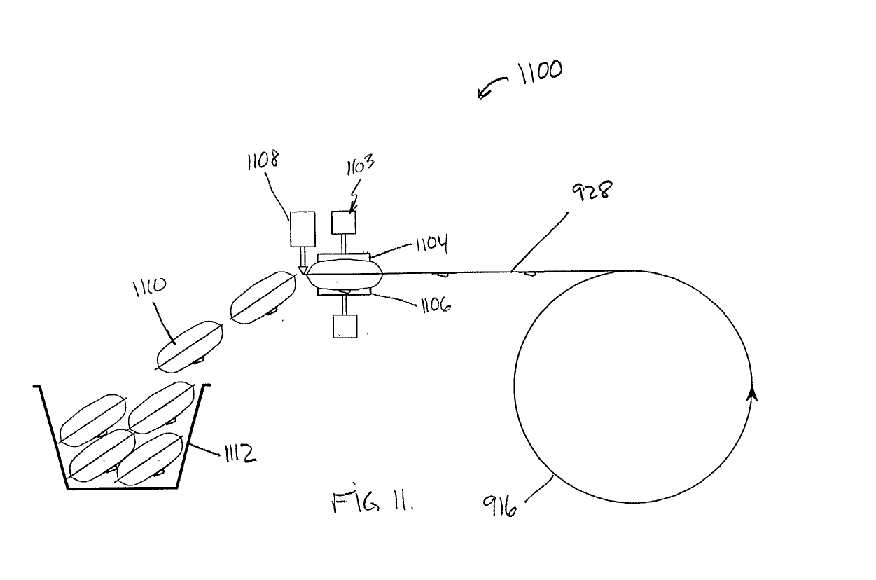

FIG. 9 shows a production machine 900 for producing the door protector of the present invention. Production machine 900 includes a top layer roll 902 and a bottom layer roll 904. Bottom layer roll 904 unrolls on production machine 900 such that a bottom layer 920 passes through a door clip attachment machine 908. Door clip segments 906 are fed perpendicular to bag material of bottom layer 920, as shown in FIG. 9. At door clip attachment machine 908, door clip segments 906 are heat-sealed to bottom layer 920. Top layer roll 902 and bottom layer roll 904 are placed so that a top layer 922 and bottom layer 920 can unroll from the rolls, to meet and lie with the top layer on the bottom layer, as is shown at 924.

After door clip segments 906 are sealed to bottom layer 920, both bottom layer 920 and top layer 922 advance through a heat sealer 910. Heat sealer 910 includes a top portion 909 and bottom portion 911. Heat sealer 910 melts top layer 922 and bottom layer 920 together to form the peripheral layer of the door protector of the present invention. Heat sealer 910 does not seal the inflation port. After heat sealer 910 bonds top layer 922 and the bottom layer 920 together, the laminate advances to a dye-cutter 912 which punches a perimeter of the bag, leaving adjacent bags connected at inflation ports for later dispensing. From dye-cutter 912, the scrap material, called trim 926 is wound onto a trim take-up reel 914. Likewise, the bag material 928, now sealed and cut, having clip segment 906 attached, is wound to a door bag take-up reel 916.

FIG. 10 shows scrap 926 and bag material 928 as they emerge from dye cutter 912 of FIG. 9. On the production machine, scrap 926 and bag material 928 are separated, each advancing to trim take-up reel 914 and door bag take-up reel 916, respectively.

Door bag take-up reel 916 is taken to a line-side dispensing machine 1100 shown in FIG. 11. Line-side dispensing machine 1100 is preferably located adjacent a vehicle assembly line. Bag material 928, as shown in FIG. 10, advances from door bag take-up reel 916 into an inflation device 1103 comprising a top vacuum plate 1104 and a bottom vacuum plate 1106 placed opposite each other. Top vacuum plate 1104 and bottom vacuum plate 1106 are pueumatic mechanisms that seal around the peripheral edge of each individual door bag. A vacuum is created within top vacuum plate 1104 and bottom vacuum plate 1106, expanding the top layer material from the bottom layer material. Because the top and bottom layers of the bag material are sealed together at a peripheral edge, air at atmospheric pressure may enter only at an inflation port, filling the bag and forming the door protector of the present invention.

The door bags of the present invention can be manufactured at any manufacturing plant, regardless of location. If the bag is inflated at a high elevation, such as in mountainous areas, the atmosphere pressure outside the bag is different than a bag inflated at sea level. A bag that is inflated at a high elevation, and shipped with a new vehicle to a dealership at sea-level, could appear to be under-inflated due to the increased pressure of the atmosphere at sea-level. Likewise, a bag that is inflated at a low elevation, such as at sea-level, and shipped with a new vehicle to a dealership at a high elevation, could appear to be over-inflated as the atmosphere pressure around the bag is lower than when the bag was originally inflated. To address this problem, the vacuum pressure in top vacuum plate 1104 and bottom vacuum plate 1106 is adjustable so that the amount of air that enters inflation port is controlled. This allows the air pressure in the air bag to be compensated for changes in elevation that will occur when the inflated bags are shipped with new vehicles to regions having different atmosphere pressures.

In one embodiment, instead of being filled to atmospheric pressure, the bag is pressurized. In this embodiment, a nozzle is connected to the inflation port, and a pressurized fluid, such as air, liquid or a gel, in forced into the bag, inflating the bag to a desired pressure. In this embodiment, it would be beneficial to use a gas impermeable material for the bladder, so as to eliminate any diffusion of the liquid through the bladder walls to avoid deflation that would occur over time.

After the door bag is filled to a desired capacity, a port sealing machine 1108 seals the inflation port and simultaneously separates the previously inflated, finished door protector attached to the inflation port of the protector being sealed.

Top vacuum plate 1104 and bottom vacuum plate 1106 release the finished door protector, and the bag material 928 is advanced to create the following door protector. Inflated door protectors are stored in a bin 1112 until use.

One distinct advantage of the present invention is that the floor space required to store the door protectors is minimized. Prior art devices are fully assembled, and stored in boxes or bins requiring a large area of floor space. A single roll of door bag take-up reel 916 contains a large number of uninflated bags, compactly stored. The floor space required to store take-up reel 916, containing uninflated bags is much less than the space required to store the same number of prior art devices. As door protectors are needed on the assembly line, the line-side dispensing machine can be operated to inflate additional door protectors.

While the invention has been particularly shown and described with reference to preferred embodiments thereof, it will be understood by those skilled in the art that various changes in form and detail may be made therein without departing from the spirit and scope of the invention.

What is claimed is:

1. An edge protector for a vehicle door comprising:
a bladder formed from a pliable material; and
means for coupling said bladder to a door edge.

2. The door-edge protector of claim 1, wherein said coupling means comprises:
a U-shaped member defining an inner channel, said inner channel configured to receive said door edge.

3. The edge protector of claim 2, wherein said U-shaped member is a plastic clip.

4. The edge protector of claim 1, wherein said means for coupling is adhesive tape.

5. The edge protector of claim 4, wherein an edge said adhesive tape is attached to said bladder and extends around an edge of the vehicle door.

6. The edge protector of claim 1, wherein printed matter is disposed within said bladder.

7. The edge protector of claim 1, wherein said bladder contains air.

8. An edge protector for a vehicle door comprising:
a clip; and
a bladder attached to said clip.

9. The edge protector of claim 8, wherein said clip is U-shaped.

10. The edge protector of claim 9, wherein said clip is heat bonded to said bladder.

11. The edge protector of claim 8, wherein said clip is attached with an adhesive to said bladder.

12. The edge protector of claim 8, wherein said bladder is formed of either high-density polyethylene or polypropylene.

13. The edge protector of claim 8, wherein said bladder includes a top layer and a bottom layer of pliable material sealed together at a peripheral edge of said top layer and said bottom layer to trap air between.

14. The edge protector of claim 13, wherein said bottom layer is colored.

15. The edge protector of claim 14, wherein said bottom layer is printed thereon.

16. An edge protector for a vehicle door comprising:
a first pliable layer; and
a second pliable layer sealed to said first pliable layer at a peripheral edge to form a bladder; and
means for attaching said bladder to a vehicle door.

17. The edge protector of claim 16, wherein said attaching means is a plastic clip.

18. The edge protector of claim 17, wherein said clip is thermally bonded to said first layer.

19. The edge protector of claim 16, wherein said attaching means is an adhesive tape.
